(19) United States
(12) Patent Application Publication
(10) Pub. No.: US 2024/0364063 A1
(43) Pub. Date: Oct. 31, 2024

(54) ELECTRICAL RECEPTACLE HAVING AN ACCESS INTERFACE

(71) Applicant: ABB Schweiz AG, Baden (CH)

(72) Inventors: Robert Fong, Hackettstown, NJ (US); George Richard Hydock, Hackettstown, NJ (US)

(21) Appl. No.: 18/308,211

(22) Filed: Apr. 27, 2023

(51) Int. Cl. H01R 31/06; H01R 13/506

(52) U.S. Cl. CPC H01R 31/06; H01R 13/506

(57) ABSTRACT

An electrical receptacle is provided. The electrical receptacle includes a housing including a cable port configured to engage a cable adapter. The cable adapter is configured to receive a cable. The housing further includes a transformer port configured to engage a transformer adapter. The housing further includes an access port configured to engage an accessory. The electrical receptacle further includes a central connector disposed within the housing. The central connector is configured to electrically couple to the cable when the cable adapter is engaged with the cable port, the transformer adapter when the transformer adapter is engaged with the transformer port, and the accessory when the accessory is engaged with the access port.

### BACKGROUND

The field of the invention relates generally to electrical receptacles, and more particularly, to an access interface for electrical receptacles used in electrical distribution systems.

When components of electrical systems such as transformers are serviced by utility personnel, each electrical phase leading to the transformer or other component must be grounded and/or tested to ensure that no dangerous voltages are present. Presently, grounding each phase generally requires cutting electrical cables carrying the phases and/or dismantling portions of the receptacles used to connect the cables to the transformer of other component. This practice is costly and time consuming, because the cable must be restored before being placed back into service. Known methods and devices are disadvantaged in some aspects and improvements are desired.

### BRIEF DESCRIPTION

In one aspect, an electrical receptacle is provided. The electrical receptacle includes a housing including a cable port configured to engage a cable adapter. The cable adapter is configured to receive a cable. The housing further includes a transformer port configured to engage a transformer adapter. The housing further includes an access port configured to engage an accessory. The electrical receptacle further includes a central connector disposed within the housing. The central connector is configured to electrically couple to the cable when the cable adapter is engaged with the cable port, the transformer adapter when the transformer adapter is engaged with the transformer port, and the accessory when the accessory is engaged with the access port.

In another aspect a housing for an electrical receptacle is provided. The housing includes a cable port configured to engage a cable adapter. The cable adapter is configured to receive a cable. The housing further includes a transformer port configured to engage a transformer adapter. The housing further includes an access port configured to engage an accessory. The housing is sized to receive a central connector to be disposed therein. The central connector is configured to electrically couple to the cable when the cable adapter is engaged with said cable port, the transformer adapter when the transformer adapter is engaged with said transformer port, and the accessory when the accessory is engaged with said access port.

In one more aspect, a method for assembling an electrical receptacle is provided. The method includes electrically coupling a central connector to a transformer adapter. The central connector is configured to further electrically couple to a cable and an accessory. The method further includes positioning a housing over the central connector. The housing includes a cable port, a transformer port, and an access port. The cable port is configured to engage a cable adapter configured to receive the cable. The transformer port is configured to engage the transformer adapter. The access port is configured to engage the accessory.

### BRIEF DESCRIPTION OF THE DRAWINGS

FIG. 1 is a perspective view of an example electrical receptacle having an access interface.

FIG. 2 is a side cross-sectional schematic of the example electrical receptacle shown in FIG. 1 taken along cross-sectional line 2-2 shown in FIG. 1.

FIG. 3 is an perspective cross-sectional view of the example electrical receptacle shown in FIGS. 1 and 2 taken along cross-sectional line 2-2 shown in FIG. 1.

FIG. 4 is a perspective view of an example central connector for use in the electrical receptacle shown in FIGS. 1-3.

FIG. 5 is a cross-sectional view of an example grounding device for use with the electrical receptacle shown in FIGS. 1-3.

FIG. 6 is a flow chart illustrating an example method for assembling an electrical receptacle such as the electrical receptacle shown in FIGS. 1-3.

### DETAILED DESCRIPTION

Example embodiments of the present disclosure include an electrical receptacle. The electrical receptacle includes a housing including a cable port, a transformer port, and an access port. The cable port is configured to engage a cable adapter, which is configured to receive a cable. The transformer port configured to engage a transformer adapter, which may be used to couple the electrical receptacle to a transformer or other electrical component. The access port is configured to engage an accessory. The electrical receptacle further includes a central connector disposed within the housing. The central connector is configured to electrically couple to the cable when the cable adapter is engaged with the cable port, the transformer adapter when the transformer adapter is engaged with the transformer port, and the accessory the accessory is engaged with the access port. Accordingly, an electrical connection is formed between the cable and the accessory when the accessory is engaged with the access port.

An example accessory that may be engaged with the access port is a grounding accessory, which enables the cable to be grounded (e.g., so maintenance can be performed on the cable or transformer) without needing to cut the cable and/or dismantle the electrical receptacle. Another example accessory is a sensing device, such as a voltage sensor or current sensor. The access port may include a standard coupling configuration (e.g., an Institute of Electrical and Electronics Engineers (IEEE) 386 connector), so that a variety of different accessories having the standard coupling configuration may be engaged with the access port.

A receptacle that enables grounding and/or testing of the electrical phases of a transformer or other component without cutting the cables or dismantling the electrical receptacle is therefore desirable. The electrical receptacle described herein solves this problem by providing an access port through which the cable may be grounded and/or tested without cutting the cables and/or dismantling the receptacle.

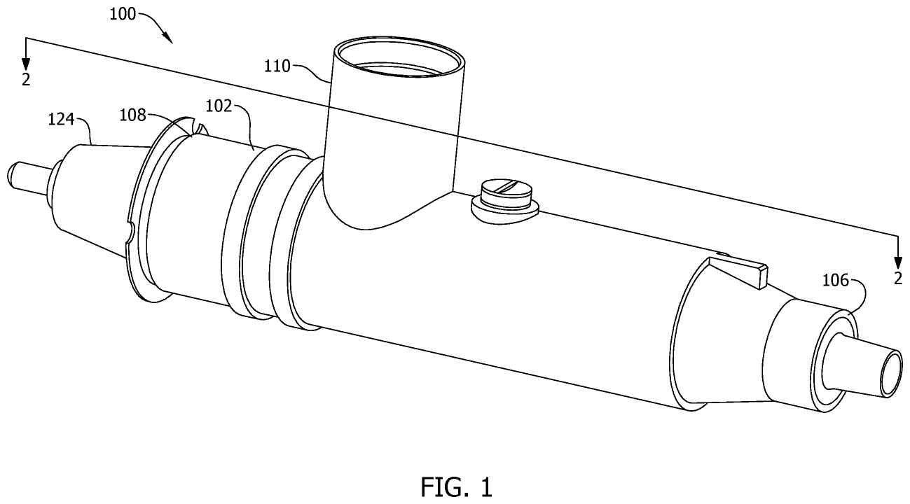

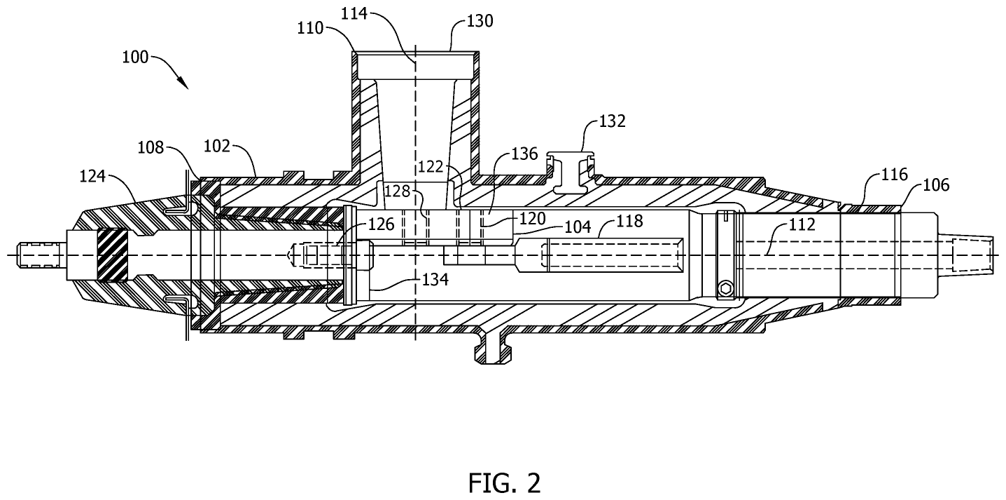

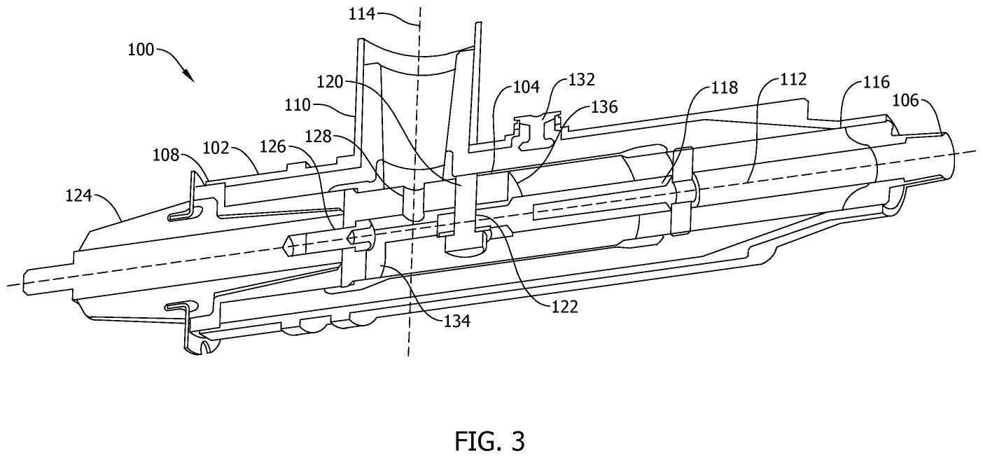

FIGS. 1-3 show an example electrical receptacle 100. FIG. 1 is perspective view of an example electrical receptacle 100, FIG. 2 is a side cross-sectional schematic of electrical receptacle 100, and FIG. 3 is an perspective cross-sectional view of electrical receptacle 100. In some embodiments, electrical receptacle 100 is configured to carry a medium voltage alternating current (AC) signal. In the example embodiment, electrical receptacle 100 includes a housing 102 and a central connector 104. Housing 102 includes a cable port 106, a transformer port 108, and an access port 110. Cable port 106 and transformer port 108 define a first axis 112, and access port 110 defines a second axis 114 that is substantially perpendicular to first axis 112. In some embodiments, housing 102 is generally tubular in shape extending along first axis 112 with a generally constant diameter that tapers proximate to cable port 106. In some embodiments, housing 102 is formed from an insulating material (e.g., ethylene propylene diene monomer (EPDM) polymer) to protect utility personnel from injuries resulting from contact with electrically conducting components of electrical receptacle 100 when electrical receptable 100 is energized.

In the example embodiment, cable port 106 is configured to engage with a cable adapter 116 that is configured to receive and retain a cable (not shown). Electrical receptacle 100 includes a crimp connector 118 that holds a conductor of the cable. Crimp connector 118 is attached to central connector 104 and forms an electrical connection between the cable and central connector 104. In some embodiments, central connector 104 includes a first internal thread 120 (see FIGS. 2 and 3) configured to receive a bolt 122 that fastens crimp connector 118 to central connector 104 (e.g., at 50 to 60 foot-pounds or about 68 to 81 newton-meters).

In the example embodiment, transformer port 108 is configured to engage with a transformer adapter 124. Transformer adapter 124 is configured to be operatively electrically coupled to a transformer or other electrical component to provide an electrical input and/or output. In some embodiments, transformer adapter 124 is attached to or formed integrally with a housing of the transformer or other electrical component. When engaged with transformer port 108, transformer adapter 124 is in electrical contact with central connector 104, such that central connector 104 may form an electrical connection between the transformer or other electrical component and the cable via transformer adapter 124 and central connector 104. In some embodiments, transformer adapter 124 is fastened to central connector 104 by a bolt 126 (e.g., at 50 to 60 foot pounds or about 68 to 81 newton-meters). In some embodiments, transformer adapter 124 forms an airtight or watertight seal with housing 102 when engaged with transformer port 108.

In the example embodiments, access port 110 is configured to engage with an accessory, which, when engaged with access port 110, is in electrical contact with central connector 104. Accordingly, access port 110 enables accessories to be electrically coupled to the cable or transformer without removal of housing 102 or dismantling of electrical receptacle 100. For example, a grounding accessory may be engaged with access port 110, which enables the cable to be grounded, for example, so that maintenance can be performed on the cable or transformer safely. Similarly, a voltage measuring device or a current measuring device may be engaged with access port 110 to measure a voltage or current present on the cable. In some embodiments, central connector 104 includes a second internal thread 128 (see FIGS. 2 and 3) configured to receive an external thread of the accessory, enabling the accessory to be fastened to central connector 104. In some embodiments, access port 110 is configured to receive a particular industry standard coupling, such as an IEEE 386 connector. In some embodiments, the accessory forms an airtight or watertight seal with housing 102 when engaged with access port 110.

In some embodiments, a cap 130 may be engaged with access port 110 when no accessory is present, in order to protect the interior of housing 102 (e.g., from entry of water or dirt).

In some embodiments, housing 102 includes a test point 132. Test point 132 is capacitively coupled to the conducting portions of electrical receptacle 100 (e.g., central connector 104, crimp connector 118, and the cable), which enables a presence of electrical signals on these conducting portions to be detected at test point 132 (e.g., using a hot stick voltage sensor). Accordingly, test point 132 may be used to determine whether the cable is de-energized before work is performed on the cable. However, because test point 132 does not enable direct electrical contact with the cable, test point 132 does not enable direct measurement or grounding of the cable, and whether the cable is deenergized is not ensured by testing at test point 132. By providing a direct electrical connection to the cable, access port 110 is advantageous in enabling direct testing and/or grounding of the cable, and ensuring safety of utility personnel.

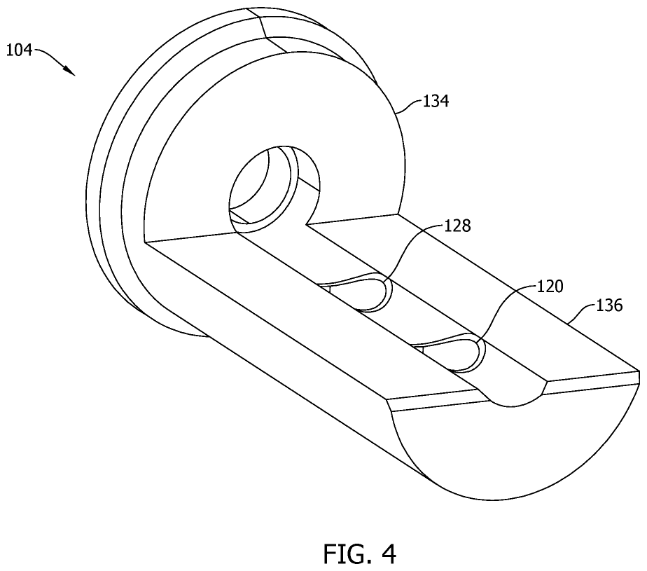

FIG. 4 is a perspective view of central connector 104. In the example embodiment, as shown in FIGS. 2-4, central connector 104 includes a radial portion 134 centered about first axis 112 and configured to receive bolt 126 (e.g., at about a center point of a radial portion 134) to securely connect central connector 104 to transformer adapter 124 (see FIGS. 2 and 3). In some such embodiments, central connector further includes a longitudinal portion 136 extending from a radial portion 134 towards cable port 106. Longitudinal portion 136 may include first internal thread 120 configured to receive bolt 122, providing connection with the cable, through cable adapter 116 and crimp connector 118. Longitudinal portion 136 may further include second internal thread 128 configured to receive the accessory such that the accessory may be securely connected to central connector 104. In the example embodiment, radial portion 134 and longitudinal portion 136 of central connector 104 form into an L shape. Alternatively, central connector 104 may be any other suitable shape that forms an electrical connection between the cable coupled to cable adapter 116, the accessory, and the transformer and/or other electrical component coupled to transformer adapter 124. In some embodiments, central connector 104 is configured to carry a medium voltage signal, such as an AC signal of about 600 amperes and about 25 kilovolts. Alternatively, central connector 104 may be configured to carry another type of signal, such as a high voltage or low voltage signal, as determined by the operating demands to be placed on electrical receptacle 100.

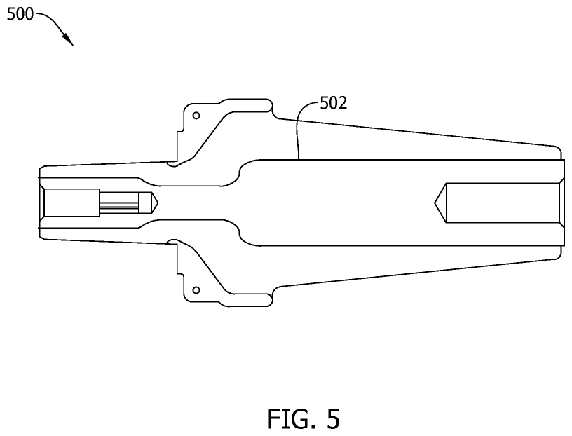

FIG. 5 is a cross-sectional view of an example grounding device 500. Grounding device 500 is configured to engage with access port 110 (shown in FIGS. 1-3). When engaged with access port 110, a conducting portion 502 of grounding device 500 is in electrical contact with central connector 104, enabling the cable coupled to cable adapter 116 to be grounded via conducting portion 502 without dismantling electrical receptacle 100.

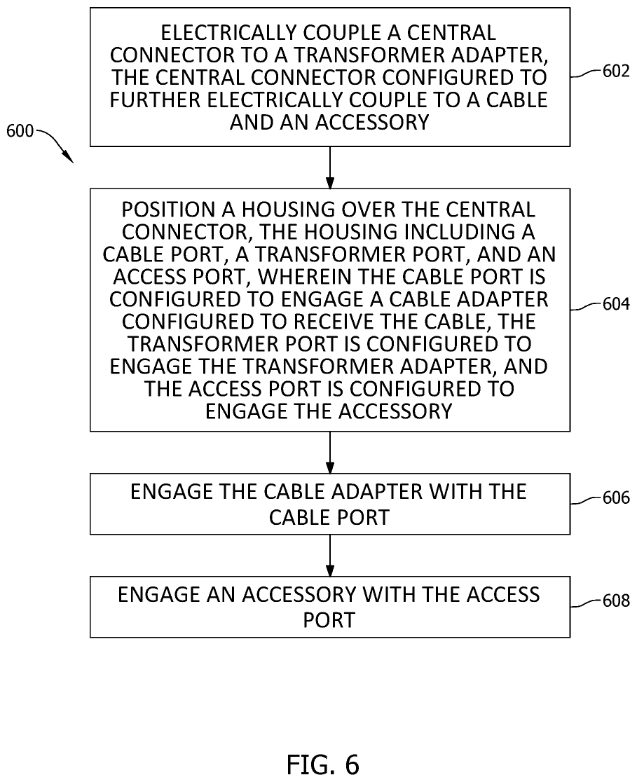

FIG. 6 is a flowchart illustrating an example method 600 for assembling an electrical receptacle (such as electrical receptacle 100).

In the example embodiment, method 600 includes electrically coupling 502 a central connector (such as central connector 104) to a transformer adapter (such as transformer adapter 124). The central connector is configured to further electrically couple to a cable and an accessory.

In the example embodiment, method 600 further includes positioning 604 a housing (such as housing 102) over the central connector. The housing including a cable port (such as cable port 106), a transformer port (such as transformer port 108), and an access port (such as access port 110). The cable port is configured to engage a cable adapter (such as cable adapter 116) configured to receive the cable. The transformer port is configured to engage the transformer adapter, and the access port is configured to engage the accessory. In some embodiments, the housing is a single piece. In some embodiments, the cable port and the transformer port are positioned along a first axis (such as first axis 112) defined by the cable port and the transformer port, and the access port defines a second axis (such as second axis 114) perpendicular to the first axis.

In some embodiments, method 600 further includes engaging 606 the cable adapter with the cable port.

In some embodiments, method 600 further includes engaging 508 an accessory, such as a grounding device, a voltage measuring device, or a current measuring device, with the access port.

At least one technical effect of the systems and methods described herein includes (a) reducing a risk of electrical injury by providing an electrical receptacle with an access port through which a cable may be grounded and/or tested for voltage prior to performing maintenance on the cable without dismantling the electrical receptacle or cutting the cable; and (b) enabling electrical access to a medium voltage cable via an electrical receptacle by providing a standardized access port that enables accessories to be electrically connected to the cable without dismantling the electrical receptacle.

Example embodiments of an electrical receptacle having an access interface are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electrical receptacle comprising:
a housing comprising:
a cable port configured to engage a cable adapter, the cable adapter configured to receive a cable;
a transformer port configured to engage a transformer adapter; and
an access port configured to engage an accessory; and
a central connector disposed within said housing, said central connector configured to electrically couple to the cable when the cable adapter is engaged with said cable port, the transformer adapter when the transformer adapter is engaged with said transformer port, and the accessory when the accessory is engaged with said access port.

2. The electrical receptacle of claim 1, wherein said central connector further comprises a first internal thread configured to engage with an external thread of the accessory.

3. The electrical receptacle of claim 1, wherein said central connector further comprises a second internal thread configured to engage with a crimp connector, the crimp connector configured to connect to the cable.

4. The electrical receptacle of claim 1, wherein said cable port and said transformer port are positioned along a first axis defined by said cable port and said transformer port, and wherein said access port defines a second axis perpendicular to the first axis.

5. The electrical receptacle of claim 1, wherein the accessory is a grounding device.

6. The electrical receptacle of claim 1, wherein the accessory is a voltage measuring device and/or a current measuring device.

7. The electrical receptacle of claim 1, wherein said access port comprises an IEEE 386 connector.

8. The electrical receptacle of claim 1, wherein the central connector is configured to carry an alternating current (AC) signal of about 600 amperes and about 25 kilovolts.

9. A housing for an electrical receptacle, said housing comprising:
a cable port configured to engage a cable adapter, the cable adapter configured to receive a cable;
a transformer port configured to engage a transformer adapter; and
an access port configured to engage an accessory,
wherein the housing is sized to receive a central connector to be disposed therein, the central connector is configured to electrically couple to the cable when the cable adapter is engaged with said cable port, the transformer adapter when the transformer adapter is engaged with said transformer port, and the accessory when the accessory is engaged with said access port.

10. The housing of claim 9, wherein said housing is a single piece.

11. The housing of claim 9, wherein said cable port and said transformer port are positioned along a first axis defined by said cable port and said transformer port, and wherein said access port defines a second axis perpendicular to the first axis.

12. The housing of claim 9, wherein the accessory is a grounding device.

13. The housing of claim 9, wherein the accessory is a voltage measuring device and/or a current measuring device.

14. The housing of claim 9, wherein said access port comprises an IEEE 386 connector.

15. A method for assembling an electrical receptacle, said method comprising:
electrically coupling a central connector to a transformer adapter, the central connector configured to further electrically couple to a cable and an accessory; and
positioning a housing over the central connector, the housing including a cable port, a transformer port, and an access port, wherein the cable port is configured to engage a cable adapter configured to receive the cable, the transformer port is configured to engage the transformer adapter, and the access port is configured to engage the accessory.

16. The method of claim 15, further comprising engaging the cable adapter with the cable port.

17. The method of claim 15, further comprising engaging a grounding device with the access port.

18. The method of claim 15, further comprising engaging at least one of a voltage measuring device or a current measuring device with the access port.

19. The method of claim 15, wherein the housing is a single piece.

20. The method of claim 15, wherein the cable port and the transformer port are positioned along a first axis defined by the cable port and the transformer port, and wherein the access port defines a second axis perpendicular to the first axis.
